(19) United States
(12) Patent Application Publication
(10) Pub. No.: US 2024/0347724 A1
(43) Pub. Date: Oct. 17, 2024

(54) STABILIZED CATHODE MATERIALS FOR LITHIUM-ION BATTERIES

(71) Applicant: Wayne State University, Detroit, MI (US)

(72) Inventors: Sudhan Nagarajan, Detroit, MI (US); Leela Mohana Reddy Arava, Troy, MI (US)

(21) Appl. No.: 18/636,627

(22) Filed: Apr. 16, 2024

Related U.S. Application Data
(60) Provisional application No. 63/459,797, filed on Apr. 17, 2023.

(51) Int. Cl. H01M 4/58; C01B 19/00; H01M 4/02; H01M 4/136; H01M 10/0525

(52) U.S. Cl. CPC H01M 4/5815; C01B 19/002; H01M 4/136; H01M 10/0525; C01P 2002/72; C01P 2006/40; H01M 2004/028

(57) ABSTRACT

A stabilized cathode composition is disclosed. The composition includes the formula: AxMChy, wherein x is 1 to 5; y is 2 to 5; A is selected from the group consisting of: Li, Na, K, Mg, and Ca; M is selected from the group consisting of Ni and Co free d-block transition metals or p-block metals or combination of two or more thereof, Ch is selected from the group consisting of S, Se or their combination with O and/or Te.

### CROSS-REFERENCE

This application claims priority to U.S. Prov. App. No. 63/459,797 filed on Apr. 17, 2023, the contents of which are hereby incorporated by reference in its entirety.

### GOVERNMENT LICENSE RIGHTS

This invention was made with government support under 2127519 awarded by National Science Foundation. The government has certain rights in the invention.

### TECHNICAL FIELD

The present disclosure relates to stabilized cathode materials for lithium-ion (Li-ion) batteries, and particularly to fast charging and high capacity chalcogen anionic redox positive electrode materials free from nickel (Ni) and cobalt (Co) metals.

### BACKGROUND

The demand for lithium-ion (Li-ion) batteries is steadily growing, and zero carbon goals for achieving a safe and sustainable society have led to intensive research on developing high performance battery materials. Conventional applications of Li-ion batteries include portable electronics, electric vehicles, and grid energy storage.

Introducing high performance Li-ion batteries in current energy storage technologies has great hope for decarbonization goals in achieving a sustainable future. The impact of Li-ion batteries in our current energy sector is formidable, especially in portable electronics and electric vehicles. Conventionally, the redox center for cathodes solely relies on cationic redox reactions involving reversible lithiation/delithiation reactions, as achieved through Ni and Co-based transition metal oxide cathodes such as LiCoO₂ and LiNixMnyCozO₂ (x+y+z=1) (“NMC”). However, the state of art cathode materials with Ni and Co-based oxide cathodes are already approaching their theoretical limits, especially since most of the current cathode materials' specific capacity is limited to 180 mAh/g to 200 mAh/g. Unlike traditional transition metal redox cathodes, the introduction of multielectron Li-rich cathode chemistry by exploiting cationic and anionic redox during Li extraction is highly advantageous to improve the specific capacity and energy density of the current cathode materials. Compared to conventional cathodes, anion redox cathode chemistry is not straightforward as it goes through a complex redox reaction pathway, leading to fundamental issues such as voltage fade, voltage hysteresis, and irreversible oxygen release.

The fundamental driving force for achieving anionic redox is the tuning of covalency between metal and ligand present in the cathode structural framework. During anionic redox participation, the hole stabilization on the anions will also impact the reversible anionic redox reaction, otherwise the anions such as O²⁻ will release molecular oxygen (O²) from the crystal lattice. This is the reason why the complex O²⁻ anion redox stabilization demonstrated efferently in the covalent (tightness between metal and oxygen) Ru—O and Ir—O metal-ligand environment compared to the Mn—O environment. The investigations of model compounds added significant knowledge to the anion redox chemistry, but the Ru- and Ir-based compositions are impractical due to their cost. Though the fundamental understanding has been improved significantly, a practically viable Li-rich NMC cathode still suffers from fundamental degradations and its commercialization is hindered by sluggish kinetics, voltage fade, and voltage hysteresis.

The establishment of improved metal-ligand covalency may provide reversible sulfide anionic redox reactions in various chalcogen structural frameworks. This chalcogen introduction in the band structure also improves the metal d-band penetration into the ligand p band due to its lower electronegativity compared with oxides. In addition, the tightness between metal and chalcogen could be further improved by moving towards less electronegative Se and Te introduction in the electronic structure of the chalcogen frameworks.

In view of the problem mentioned, there is a need for improved Li-ion batteries with fast charging and high capacity cathode materials.

According to the present disclosure, there is provided a fast charge capable cathode material for a lithium-ion battery and method of making the same, as set forth in the appended claims.

### SUMMARY

The disclosure provides fast charging and high capacity chalcogen anionic redox positive electrode (cathode) materials free from nickel (Ni) and cobalt (Co) metals for insertion ion (e.g., Li-ion) batteries).

According to a first aspect, there is provided a fast charge capable cathode material for an insertion ion (e.g., Li-ion) battery. The cathode material includes a composition having the formula: AₓMCh_{y}, wherein x is 1 to 5; y is 2 to 5; A is selected from the group consisting of: Li, Na, K, Mg, and Ca; M is selected from the group consisting of Ni-free and Co-free d-block transition metals or p-block metals or combination of two or more thereof; Ch is selected from the group consisting of S and/or Se alone or combined with O and/or Te.

The d-block transmission metals are selected from the group consisting of: Ti, V, Cr, Mn, Fe, Cu, Zr, Nb, and Mo. Additionally or alternatively, the p-block metals are selected from the group consisting of: Al, Sn, Sb, Si, and In.

Pursuant to an implementation, the composition has the formula: Li_{1+(1-(a+b))}MₐM^{R}_{b}X_{2-y}X^{R}_{y}, wherein a+b≤1; y=0.01≤y≤1, and pursuant to a further implementation y=0.1≤y≤1; M and M^{R} are selected from the group consisting of the Ni-free and Co-free d-block transition metals or P-block metals or combination of two or more thereof; X and X^{R} are selected from the group consisting of S and/or Se alone or combined with O and/or Te.

Pursuant to a further implementation, wherein the composition has the formula: Li_{1+(1-(a+b))}TiₐFe_{b}S_{2-y}Se_{y}, wherein a+b≤1, and y=0.1≤y≤1.

Pursuant to a further implementation, the composition has the formula: Li_{1.13}Ti_{0.57}Fe_{0.3}S_{2-y}Se_{y}, wherein y=0.1, 0.25, 0.5, or 1.

According to another aspect, there is provided a lithium-ion battery including an anode, a cathode, a separator disposed between the cathode and the anode, and an electrolyte on either side of the separator. The cathode material has a composition with the formula: AₓMCh_{y}, wherein x is 1 to 5; y is 2 to 5; A is selected from the group consisting of: Li, Na, K, Mg, and Ca; M is selected from the group consisting of Ni-free and Co-free d-block transition metals or p-block metals or combination of two or more thereof; Ch is selected from the group consisting of S and/or Se alone or combined with O and/or Te.

Pursuant to an implementation, the separator comprises a microporous polymer membrane. The membrane may be monolayer (e.g., monolayer polypropylene) or trilayer.

Pursuant to an implementation, the cathode is coated onto a carbon current conductor.

Pursuant to an implementation, the anode comprises an Li foil or Li₄Ti₅O₁₂ (LTO) or Graphite or an Si alloy or an Sn alloy.

Pursuant to an implementation, the electrolyte comprises 1M lithium hexafluorophosphate (LiPF₆) in ethylene carbonate (EC) and dimethyl carbonate (DMC) with or without electrolyte additives. The additives may be, but not limited to, fluoroethylene carbonate (FEC) and lithium difluoro(oxalate)borate (LiDFOB).

Pursuant to an implementation, the cathode material has the formula: Li_{1+(1-(a+b))}MₐM^{R}_{b}X_{2-y}X^{R}_{y}, wherein a+b≤1; y=0.01≤y≤1, and pursuant to a further implementation y=0.1≤y≤1; M and M^{R} are selected from the group consisting of the Ni-free and Co-free d-block transition metals or P-block metals or combination of two or more thereof; X and X^{R} are selected from the group consisting of S and/or Se alone or combined with O and/or Te. The d-block transmission metals are selected from the group consisting of: Ti, V, Cr, Mn, Fe, Cu, Zr, Nb, and Mo. The p-block metals are selected from the group consisting of: Al, Sn, Sb, Si, and In.

Pursuant to a further implementation, the composition has the formula: Li_{1+(1-(a+b))}TiₐFe_{b}S_{2-y}Se_{y}, wherein a+b≤1, and y=0.01≤y≤1, and pursuant to a further implementation y=0.1≤y≤1. For example, the composition has the formula: Li_{1.13}Ti_{0.57}Fe_{0.3}S_{2-y}Se_{y}, wherein y=0.1, 0.25, 0.5, or 1.

According to another aspect, there is provided a method of forming a cathode active material for an insertion ion battery. The method includes the steps of: a) providing precursors of Li₂S, Ti, Se, and FeS; b) mixing the precursors in a stochiometric amount to obtain a desired composition; c) heating the mixed composition in a predetermined process to form the desired composition with the formula Li_{1+(1-(a+b))}TiₐFe_{b}S_{2-y}Se_{y}, wherein a+b≤1 and y=0.01≤y≤1, and pursuant to a further implementation y=0.1≤y≤1; and wherein Se²⁻ ions are doped into S²⁻ ion sites.

Pursuant to an implementation, mixing the precursors may include grinding with a mortar and pestle for a predetermined duration in an inert environment.

Pursuant to an implementation, heating the mixed composition in the predetermined process includes sealing the mixed composition under vacuum and heating to a predetermined temperature at a predetermined heating rate. The predetermined temperature may be about 750° C. and the predetermined heating rate may be about 30° C./hour.

Pursuant to an implementation, heating the mixed composition according to the predetermined process may further include cooling the mixed composition from the predetermined temperature to room temperature at a cooling rate of 30° C./hour to 60° C./hour.

### BRIEF DESCRIPTION OF THE DRAWINGS

While the claims are not limited to the illustrated embodiments, an appreciation of various aspects is best gained through a discussion of various examples thereof. Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the disclosed subject matter described herein is not intended to be exhaustive or otherwise limiting or restricting to the precise form and configuration shown in the drawings and disclosed in the following detailed description. Examples of the present disclosed subject matter are described in detail by referring to the drawings as follows.

FIG. 1 is a schematic illustration of an exemplary lithium-ion battery according to the disclosure;

FIG. 2 is a flowchart showing an exemplary method of forming a cathode active material according to the disclosure;

FIG. 3A is an X-ray diffraction pattern of Li_{1.13}Ti_{0.57}Fe_{0.3}S_{2-y}Se_{y} (y=0.1, 0.25, 0.5, and 1), and the simulated XRD pattern of Li_{1.13}Ti_{0.57}Fe_{0.3}S₂.

FIG. 3B is a zoomed in version of the XRD patterns of FIG. 3A.

FIG. 4A illustrates the electrochemical performance of Li_{1.13}Ti_{0.57}Fe_{0.3}S_{2-y}Se_{y} (y=0.1, 0.25, 0.5, & 1) cathode materials tested against Li metal reference electrode at 10 mA/g current density and shows the galvanostatic charge discharge profiles of (a) y=0.1 Se.

FIG. 4B illustrates the electrochemical performance of Li_{1.13}Ti_{0.57}Fe_{0.3}S_{2-y}Se_{y} (y=0.1, 0.25, 0.5, & 1) cathode materials tested against Li metal reference electrode at 10 mA/g current density and shows the galvanostatic charge discharge profiles of (b) y=0.25 Se.

FIG. 4C illustrates the electrochemical performance of Li_{1.13}Ti_{0.57}Fe_{0.3}S_{2-y}Se_{y} (y=0.1, 0.25, 0.5, & 1) cathode materials tested against Li metal reference electrode at 10 mA/g current density and shows the galvanostatic charge discharge profiles of (c) y=0.5 Se.

FIG. 4D illustrates the electrochemical performance of Li_{1.13}Ti_{0.57}Fe_{0.3}S_{2-y}Se_{y} (y=0.1, 0.25, 0.5, & 1) cathode materials tested against Li metal reference electrode at 10 mA/g current density and shows the galvanostatic charge discharge profiles of d) y=1 Se at 10 mA/g current density.

FIG. 4E is a plot of the voltage hysteresis profiles of y=0, 0.5 and 1 compositions. The voltage hysteresis was plotted using the 3rd cycle of galvanostatic charge-discharge profiles. All electrochemical tests were conducted using 1M LiPF₆ in EC/DMC (50/50 ratio by volume) at room temperature.

FIG. 5A illustrates the electrochemical performance of Li_{1.13}Ti_{0.57}Fe_{0.3}S_{2-y}Se_{y} cathode materials tested against Li metal reference electrode and shows (a) Rate performance of Li_{1.13}Ti_{0.57}Fe_{0.3}S_{2-y}Se_{y} (y=(0, 0.5, 1)). (Lowest current density is 10 mA/g, and highest current density is 200 mA/g).

FIG. 5B illustrates the electrochemical performance of Li_{1.13}Ti_{0.57}Fe_{0.3}S_{2-y}Se_{y} cathode materials tested against Li metal reference electrode and shows (b) Galvanostatic charge discharge profiles of y=0.25 composition.

FIG. 5C is a plot of the specific capacity versus cycle number and shows the (c) Cycling stability of y=0.25 composition at 100 mA/g current density. All electrochemical tests were conducted using 1M LiPF₆ in EC/DMC (v/v) at room temperature.

FIG. 6 is a schematic representation of Se substituted chalcogen anion redox cathode. Based on the band position of Fe 3d band, initial Li extraction can be compensated by Fe^{2+/3+} redox reaction followed by Se^{2-/n-} redox and S^{2-/n-} (n<2) anionic redox reactions.

FIG. 7 is a differential capacity (dQ/dV) plot generated for the Se substituted compositions. The plot clearly indicates that the Se addition shifts oxidation and reduction potential of the cathode compositions.

FIG. 8A are first cycle voltage profiles of different Se compositions.

FIG. 8B are third cycle voltage profiles of different Se compositions.

FIG. 9A are cyclic voltammetry profiles of 0.1 Se substituted composition.

FIG. 9B are cyclic voltammetry profiles of 0.25 Se substituted composition.

FIG. 10A is a plot of the cycle number versus specific capacity of three different Se compositions (0, 0.1, 0.25 Se). Low current density—20 mA/g (C/10) and high current density 2000 mA/g (>10 C).

FIG. 10B is a plot of the continuous charge discharge cycling (100 mA/g, ˜C/2 rate) after rate performance of FIG. 10A.

### DETAILED DESCRIPTION

Despite 30 years of active research in the field of Li-ion battery chemistry, the current energy demands attracted materials chemists and engineers to develop new battery chemistries or redox mechanisms with high capacity and high energy density properties. Current state-of-the-art Li-ion batteries are reaching their theoretical limit with respect to their capacity that so far relied solely on cationic redox of transition metal ions (e.g., M^{3+/4+} in LiMO₂ where M is selected from Co, Ni, and Mn). The advent of anion redox chemistry in Li-rich oxides has great hope in increasing energy density but the Li-rich layered oxides extremely suffer from fundamental issues such as voltage fade, voltage hysteresis, and irreversible oxygen release. However, anion redox through highly covalent chalcogen (S/Se) is emerging due to their improved covalency between metal and ligand. Understanding the covalent interaction between metal and ligand towards highly reversible lithiation/delithiation is of paramount importance to develop high-capacity positive electrode materials.

Within this context, the inventors have found that the multi chalcogen S/Se p-band and redox active metal d-band tuning in multi anion Li-rich chalcogen composition Li_{1.13}Ti_{0.57}Fe_{0.3}S_{2-y}Se_{y} (y=0-1) yields a fast charging and high capacity chalcogen anionic redox positive electrode materials free from nickel (Ni) and cobalt (Co) metals as determined through in-depth electrochemical, X-ray spectroscopy, and electronic structure investigations. Introducing Se p character in anion redox sulfides significantly improved the electrochemical reversibility in terms of cyclability and rate capability. The detailed Fe, S and Se XAS measurements revealed the redox contributors, and the Se addition significantly improved rate capability for more than 10 C. NEXAFS measurements of Ti K edge confirmed the Ti inactivity during electrochemical reaction even after significant Se p band introduction in the chalcogen framework Li_{1.13}Ti_{0.57}Fe_{0.3}S_{2-y}Se_{y} (y=0-1).

The introduction of Se states in presence of both buffer cation (d⁰—empty d states) and redox-active (dⁿ—partially filled d states) cation in a sulfide structure framework has not been evaluated before. The effect of Se substitution on chalcogen structural framework may be performed to explore the Se 4p introduction near S 3p states and their electrochemical interaction towards achieving highly reversible lithiation and delithiation reactions.

The present disclosure is based on a detailed investigation of Se substitution in Ni-free and Co-free sulfide anion redox composition and its effect on electrochemical performance and charge compensation mechanisms using fundamental electrochemistry, synchrotron spectroscopy, and fundamental electronic structure calculations. In contrast to other Se-substituted compositions, the Se-substituted compositions according to the present disclosure significantly improved the reversibility and the rate capability of lithiation and delithiation reactions at room temperature. Such materials may be used as alternative cathode materials with less reliance on critical battery materials such as Ni and Co metals.

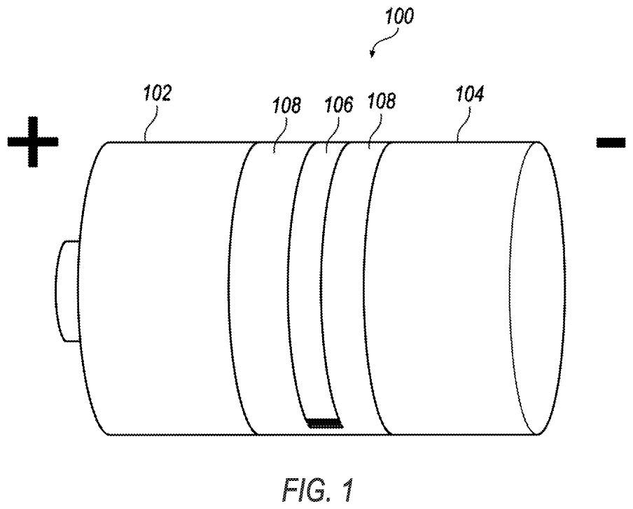

Referring now to the figures, FIG. 1 illustrates a lithium-ion battery 10 according to one exemplary approach. The lithium-ion battery 100 may be a “conventional” battery having a cathode 102, an anode 104, a separator 106 provided between the cathode 102 and the anode 104, and an electrolyte 108 in contact with the cathode 102 and the anode 104. The lithium-ion battery 100 may also include a separator 108 between the anode 102 and the cathode 104. The separator 108 may be, for example, a microporous polymer (e.g., polypropylene) membrane (e.g., monolayer or trilayer) such as commercially available Celgard® membrane separators, quartz, or glass fiber.

The electrolyte may be a liquid electrolyte or a solid electrolyte. The electrolyte 108 may comprise an Li salt and a solvent. Merely as an example, the electrolyte 108 may include, but is not limited to, 1M lithium hexafluorophosphate LiPF₆ in ethylene carbonate (EC) and dimethyl carbonate (DMC) in a 1:1 ratio (50/50 ratio by volume).

The anode 104 may comprise a material including, but not limited to, Li foil and Li₄Ti₅O₁₂ (LTO).

Pursuant to the disclosure, the cathode 102 is free from Ni and Co. The cathode material may be coated onto a current conductor, e.g., a carbon current collector and/or a carbon coated aluminum current collector. The cathode material comprises a composition having the empirical formula AₓMCh_{y}, wherein x is 1 to 5; y is 2 to 5; A is selected from Li, Na, K, Mg, and Ca; M is selected from Ni-free and Co-free d-block transition metals or p-block metals or combination of two or more thereof; Ch is Chalcogen consisting of S and/or Se alone or combined with O and/or Te.

By way of example, the d-block transition metals that are Ni-free and Co-free include, but are not limited to, Ti, V, Cr, Mn, Fe, Cu, Zn, Zr, Nb, Mo, Ag, Ta, Pt, and Au. The p-block metals include, but are not limited to, Al, Ga, Sn, Sb, In, Tl, and Bi.

Pursuant to an implementation, the material of the cathode 102 has the formula Li_{1+(1-(a+b))}MₐM^{R}_{b}X_{2-y}X^{R}_{y}, wherein a+b≤1; y=y=0.01≤y≤1, and pursuant to a further implementation 0.1≤y≤1; M and M^{R} are selected from the group consisting of Ni-free and Co-free d-block transition metals or p-block metals or combination of two or more thereof; X and X^{R} are selected from Chalcogens consisting of S and/or Se alone or combined with O and/or Te. Pursuant to a further implementation, the cathode material has a composition represented by the formula: Li_{1+(1-(a+b))}TiₐFe_{b}S_{2-y}Se_{y}, wherein a+b≤1, and y=0.01≤y≤1, and pursuant to a further implementation y=0.1≤y≤1. By way of a non-limiting example, the composition of the cathode material is represented by the formula Li_{1.13}Ti_{0.57}Fe_{0.3}S_{2-y}Se_{y}, wherein y=0.1, 0.25, 0.5, or 1.

### Results and Discussion

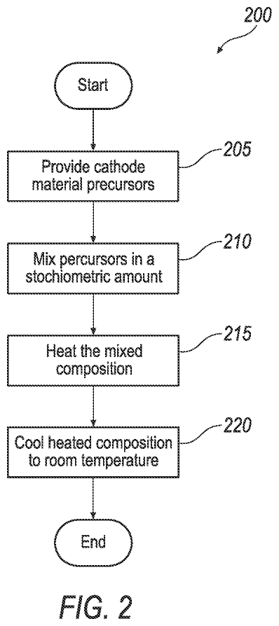

Initially, Li-rich transition metal sulfides and Se-substituted compositions were synthesized by high temperature solid state synthesis. FIG. 2 shows an exemplary method 200 for forming the cathode material according to the disclosure. At step 205, the precursor materials for the cathode are provided. The precursors comprise Li₂S, Ti, FeS, S, and Se. At step 210, the Li₂S, FeS, and Se, S precursors were mixed in a stoichiometric amount to achieve the cathode composition formula Li_{1+(1-(a+b))}TiₐFe_{b}S_{2-y}Se_{y} where a+b≤1, and y=0.01≤y≤1, and pursuant to a further implementation y=0.1≤y≤1. Further, the mixture was ground well with agate mortar and pestle for a predetermined duration (e.g., 30 minutes) in an inert atmosphere or environment (e.g., inside an Ar-filled glove box (O₂<1 ppm)). At step 215, the precursors were loaded in a carbon coated quartz ampoule and heat sealed under vacuum condition (<10⁻⁴ bar). The ampoule was heated to a predetermined temperature (e.g., about 750° C. (+/−10° C.)) at a predetermined heating rate (e.g., about 30° C./hour+/−5° C.) followed by dwelling for a predetermined duration (e.g., 36 hours) and then cooled down to room temperature at a predetermined cooling rate (about 30° C./hour (+/−5° C.) at step 220. A cathode material with the formula Li_{1+(1-(a+b))}TiₐFe_{b}S_{2-y}Se_{y} where a+b≤1, and y=0.1≤y≤1 was obtained where samples including black color crystal for the pristine and Se-doped samples that were saved inside the glove box for further characterization. The Se²⁻ ions were doped into S²⁻ ion sites by heating to activate mixed cationic (Fe^{2+/3+}) and anionic (Ch—S/Se) redox reactions. The heating for doping the Se²⁻ ions into S²⁻ ions or ion sites may be performed in step 215. Alternatively, the heating for doping the Se²⁻ ions into S²⁻ ions or ion sites may be formed in a separate step.

The synthesis was carried out in a carbon-coated quartz tube sealed under vacuum. Carbon coating in the quartz ampules is used to prevent alkali metal reactions with the quartz ampules at high temperatures. Originally, the XRD pattern of the parent compound (Fe substituted Li₂TiS₃) was simulated using crystallographic information. The composition was crystallized into an R-3m space group, and the structure is a derivative structure of Li₂TiS₃ which is a Li-rich layered structural framework C2/m space group. In this structure, a lithium layer is sandwiched between two transition metal layers. Ti and Li ions are octahedrally coordinated, and excess Li ions partially occupy titanium (Ti) positions in the transition metal layer. Lithium ions residing in the lithium layer will be extracted when delithiation occurs during charging. Using this parent structure, Se-substituted compositions were stoichiometrically prepared to understand electrochemical and electronic structural properties in one of the seminal mixed anionic and cationic redox compositions.

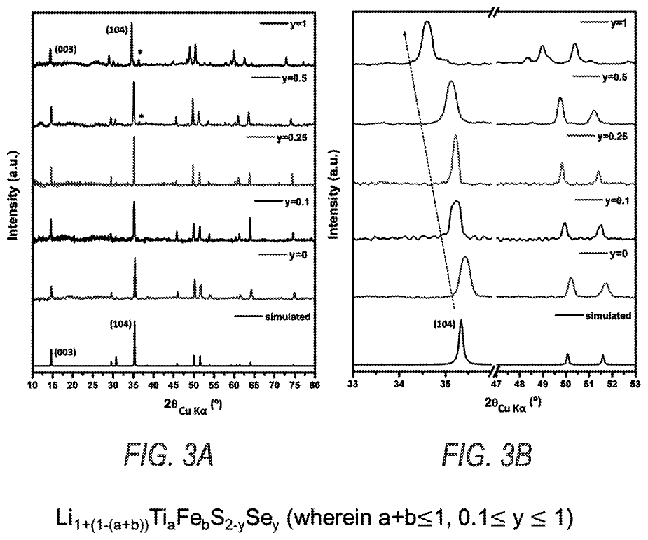

X-ray Diffraction patterns of the as-synthesized parent composition along with its simulated powder pattern and Se-substituted compositions are shown in FIGS. 3A-3B. After controlled Se addition, the XRD patterns of the Se added composition show negligible changes in the diffraction patterns except for the Bragg peaks progressively shifted to the left side as Se content increases. This phenomenon is visualized in FIG. 3B where the Bragg peaks progressively shifted to the left. Based on the diffraction patterns, it is clearly seen that the Se addition did not change the crystal structure and symmetry, but the peak shift is a result of lattice expansion from larger selenium atoms compared to sulfur atoms. However, in contrary to lower Se composition, a few additional peaks emerged in the XRD pattern of the high Se content composition that may be due to impurity phases. Conversely, the other compositions clearly confirmed that the Se substitution mixed well with the sulfur anion lattice without changing the crystal structure, but lattice expansion occurred due to larger Se atoms. Further, homogeneous distribution of Ti, Fe, S, and Se in the different compositions were qualitatively confirmed with the EDAX mapping. Low Se content compositions suffered from significant charging effect while doing microscopy investigations, therefore the EDAX images were collected to only high Se content compositions. The HAADF and EDAX mapping images for y=0.5 and 1 were then taken. After confirming the structural purity, all the Se compositions were subjected to electrochemical lithiation (discharge) and delithiation (charge) investigations at room temperature.

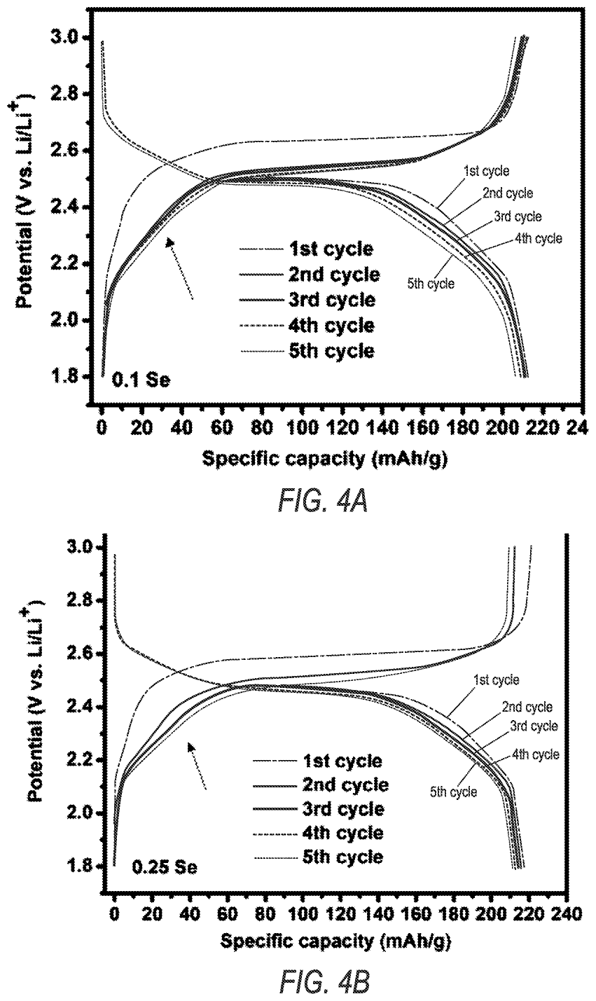

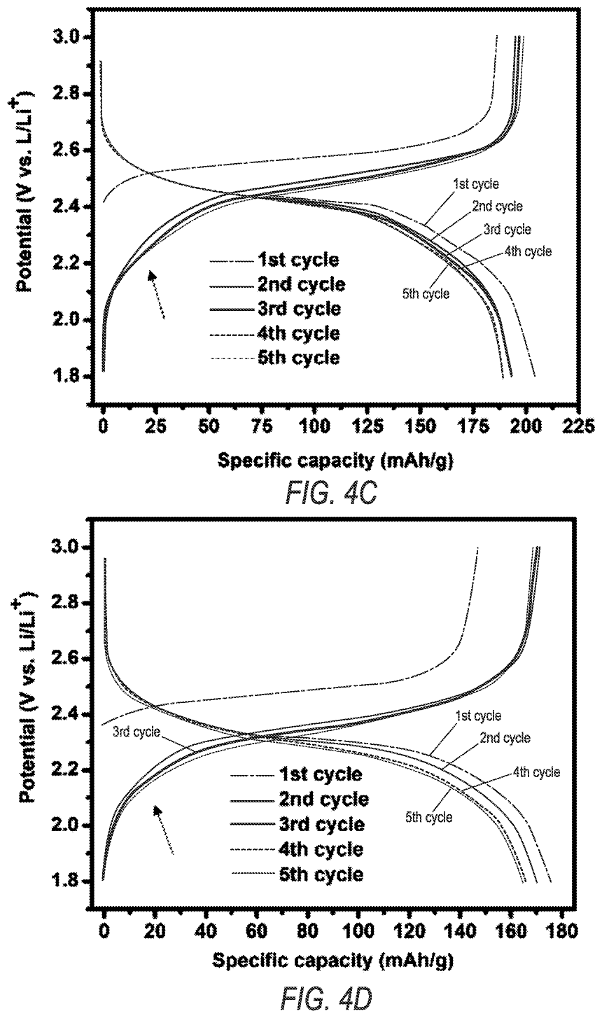

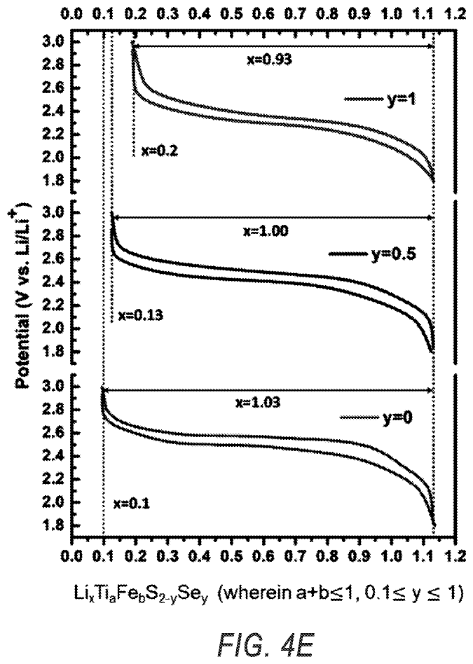

To understand the effect of Se substitution in the sulfide frameworks, a detailed electrochemical investigation was carried out in different Se-substituted compositions. FIGS. 4A-4E demonstrate the galvanostatic charge-discharge profiles of Se-substituted compositions (Li_{1.13}Ti_{0.57}Fe_{0.3}S_{2-y}Se_{y}, wherein y=0.1, 0.25, 0.5, and 1). The voltage profiles demonstrated reversible lithium storage behavior without any significant irreversibility in the potential region of 1.8 V to 3 V vs. Li. That the observed charge profiles in some of the compositions are lower than the discharge profiles can be attributed to the Li deficiency caused by the high temperature solid-state synthesis. This observation vanishes after consequent cycles which obtained enough amount of Li ions during insertion and extraction in the potential regime. In addition, the voltage profiles look similar in the Se-substituted compositions, but the slight voltage fade has been noted in the first five continuous charge discharge cycles at a low current density of 10 mA/g. This phenomenon is due to the mixed anionic and cationic redox chemistry that changes the local environment of the materials during the initial electrochemical reactions as it was demonstrated by the difference between first and second cycle in charge profiles. The voltage profiles clearly indicate that the Se substitution impacted the electrochemical Li extraction potential and the amount of Li extraction significantly. The Se-substituted compositions exhibited less capacity and less redox voltage compared to traditional Li-rich chalcogen composition. After Se substitution, the local electronic structure of the sulfide framework is changing, and this process shifted the redox behavior to lower potential when increasing the Se content. Similar observations have been witnessed previously in the composition Li₂FeS₂, where the Se substitution approach was used to control the covalency and redox potential behavior, but the strategy detrimentally affected the parent sulfide framework.

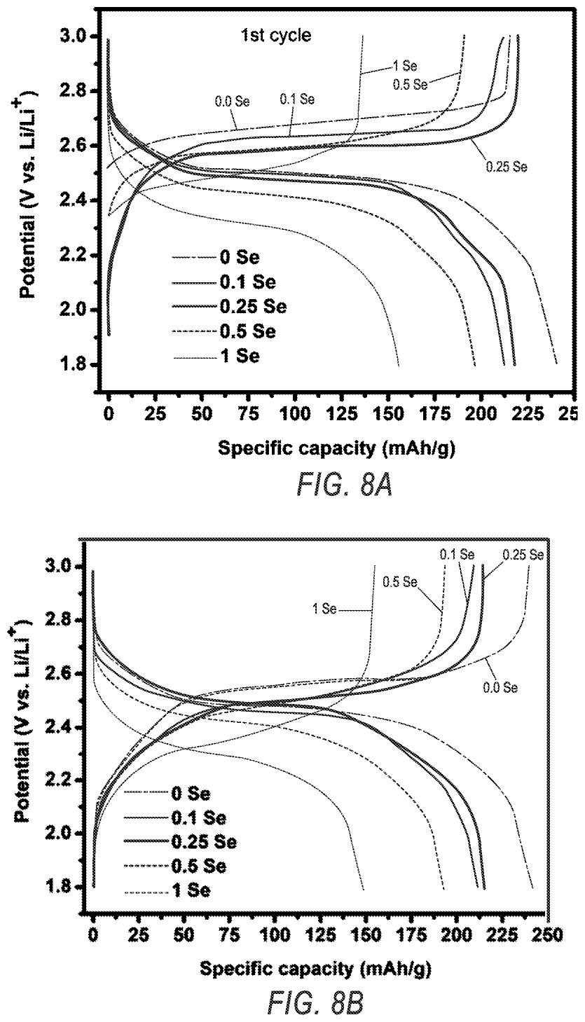

By closely looking at the voltage profiles, there are two significant regions: a low voltage sloped region followed by a plateau region as shown in FIGS. 4A-4D. This similar behavior was observed in other mixed cationic and anionic redox chemistry previously reported even in oxygen anion redox compositions. Considering this phenomenon, we believe that similar behavior is replicated in the Se-substituted compositions as the initial sloped region is attributed to cationic redox and the plateau region is dominated by mainly chalcogen redox. Interestingly, there is a clear trend that the Se addition progressively shifts the observed voltage profiles, but the sloped voltage region is affected by Se content significantly. The shift in the redox potential was confirmed with the dQ/dV plot in which the dQ/dV curves shifted systematically to low as the Se content increases (FIG. 7). Further, the difference in voltage profiles of different Se substituted compositions are shown in FIG. 8A-8B. Based on the theoretical capacity of the compositions (Table 1), the maximum cationic Fe^{2+/3+} redox is averaged around 60 mAh/g and the maximum is 69 mAh/g for 0.1 Se and 49 mAh/g for 1 Se. In addition, the sloped voltage region is constantly reduced after Se addition, indicating that Se addition decreases the gravimetric capacity and the demand for the Fe redox may be reduced. Further, the plateau regions contribute to chalcogen redox, mainly S redox contribution but the Se contribution is buried in the plateau if Se is preferentially oxidized. Therefore, decoupling Se redox from the voltage plateau is a challenging task as the plateau region originated from the mixed chalcogen states S 3p/Se 4p orbitals. However, if Se²⁻/Se¹⁻ and preferential oxidation are assumed, the maximum Se capacity contribution in the high Se content is 164 mAh/g (Table 1).

TABLE 1
Theoretical capacity and hypothetical charge compensation

| | 0 Se | 0.1 Se | 0.25Se | 0.5 Se | 1 Se |
|---|---|---|---|---|---|
| Mol. wt. (g/mol) | 116.03 | 120.722 | 127.756 | 139.479 | 162.926 |
| 1.13 Li | 261 | 250 | 237 | 217 | 185 |
| 0.3 Fe (Fe^{2+/3+}) | 69 | 66 | 63 | 58 | 49 |
| 1e− Se (Se^{2-/1-}) | 0 | 22 | 52 | 96 | 164 (Not |
| | | | | | possible) |
| 1e− S (S^{2-/1-}) | 192 | 162 | 102 | 83 | 164 (not |
| | | | | | possible) |
| Experimental | 240 | 220 | 220 | 200 | 170 |

Theoretical capacities are in mAh/g. 1.13 Li is considered to calculate maximum capacity from the structure, but 1.13 Li is experimentally not viable. For Fe, S, and Se redox, one electron transfer is considered.

Unfortunately, this capacity cannot be possible because the high Se content cathode theoretical capacity is 185 mAh/g and the experimental capacity is approximately 170 mAh/g. If the low voltage Fe redox of 50 mAh/g is utilized, the remaining 120 mAh/g is compensated by chalcogen redox mainly by combined S/Se redox contribution. Similarly, the maximum theoretical capacity contribution of Se was given in the table. From the analysis, it is clearly indicating that Fe/S/Se contribution is highly dependent on the covalent interaction present in the structures that decide the individual dominance in the observed electrochemical behavior. This analysis can be further demonstrated with theoretical calculations that will elucidate the charge compensation along with spectroscopy investigations.

In FIG. 4E, the amount of Li extraction and its associated voltage hysteresis were compared in selected chalcogenide compositions (y=0, 0.5, and 1). It is clearly seen that the Se substitution reduces the Li extraction gradually, and the voltage hysteresis is not impacted significantly in the potential region used in this study. The low specific capacity of the Se-substituted materials is due to the charge population on the S/Se environment in the electronic structure of the materials. Since the electrode potential is shifted after Se substitution, only a limited amount of Li can be extracted from the material in the potential region in this study. In these materials, the Li extraction is believed to be compensated by cationic Fe^{2+/3+} redox and chalcogen anionic redox (S/Se) reactions. The Ti cation is present in a tetravalent state [Ti⁴⁺−3d⁰(t₂_{_{g}}⁰e_{g}⁰)], so it is believed that this cation is not involved in the electrochemical reaction in the potential region used in this study. However, increasing the lower cut-off potential will deliver high Li insertion by compensating electrons from lower Tiⁿ⁺ (n<4) redox couple evolutions. However, this may lead to other complexities such as structural instability and further irreversible electrochemical reactions. To avoid these complexities, the potential region used throughout this disclosure is 1.8-3V vs. Li, even after different Se substitutions.

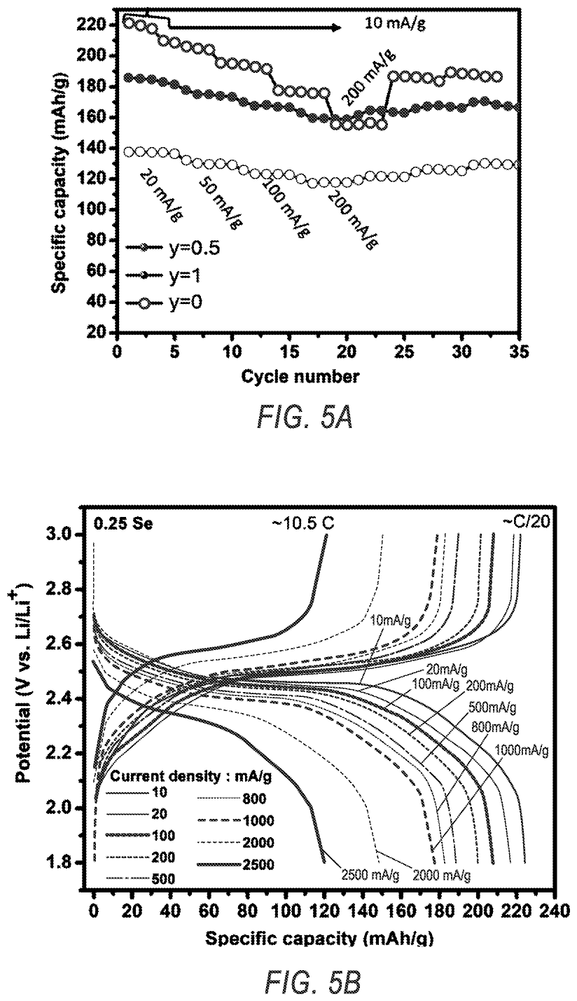

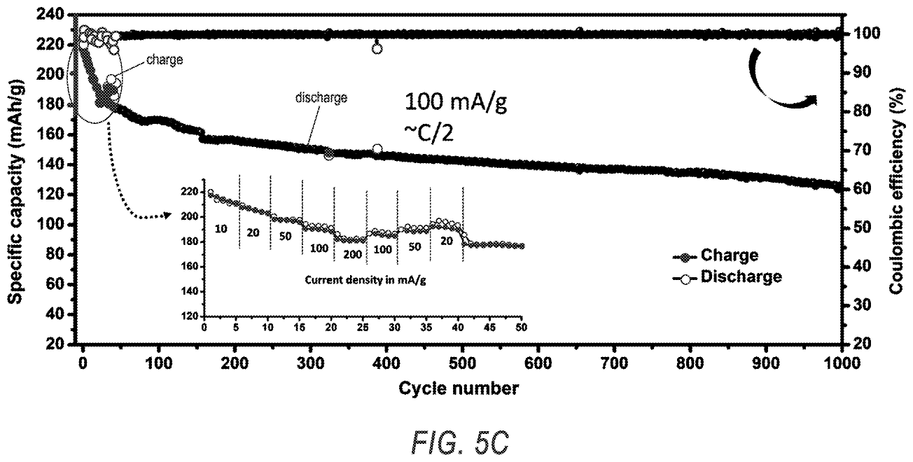

When the Se content is increased, the specific capacity is lowered due to the high molecular weight of the Se atom which reduced the theoretical Li extraction from the material. Therefore, this energy penalty leads to less Li extraction compared to other compositions in the potential region. The effect of heavier Se introduction in the sulfide framework for Li extraction/insertion capability with respect to rate is shown in FIG. 5A. Interestingly, the Se-substituted cathode demonstrates high-rate capability even at a high current density of 200 mA/g (more than 1 C for high Se cathodes (y=1)/185 mA/g is 1 C) compared to the sulfide cathode. It was clearly seen that the high Se-substituted composition possesses less difference between low-rate and high-rate cycling conditions and also the capacity of the cathode after a high rate is almost recovered at low current density. The difference in rate capability of Se-substituted composition is key to achieving fast charging Li storage materials and also exploring possibilities for coupling with chalcogen solid-state battery developments.

Based on the results, it is a trade-off that adding more Se in the sulfide framework is leading to lower capacity, but significantly improves rate capability. Fundamentally, Se possesses more metallic character than S, but the electronic conductivity cannot be the only reason for this high-rate capability. Apart from the electronic conductivity, without being bound by theory we believe the high-rate capability is related to an intrinsic property of the cathode materials as the Se addition expands crystal lattice and that expansion may lead to better Li motion at high current rate by establishing better electrostatics around Li motion. In order to efficiently utilize this advantage, a minimum Se content was added to the sulfide framework without compromising average voltage and specific capacity. Therefore, additional Se added compositions 0.1 and 0.25 species were tested for rate performance followed by cycling stability. FIG. 5B shows voltage profiles of 0.25 Se-substituted cathode at different current densities starting from C/20 to more than 10 C. Interestingly, kinetic polarization of the observed voltage profiles at different current densities seems to be minimal, indicating that the rate performance is an intrinsic behavior of the material rather than the sole correlation of electronic conductivity (ohmic polarization) of the materials. As a comparison, electrochemically important compositions (y=0.1 and 0.25) are evaluated for rate dependency followed by cycling stability at 100 mAh/g (approximately C/2). Even after high-rate testing, the 0.25 Se substituted-composition exhibited excellent reversibility by attaining up to 1000 continuous charge-discharge cycles with minimal capacity decay (FIG. 5C). Other compositions were tested for cycling stability (supporting information), but 0.25 Se exhibited excellent stability even after handling an extremely high rate for about more than 10 C, confirming that the Se addition can modify the electronic structure of the sulfide framework for achieving a better rate capability and cycling stability.

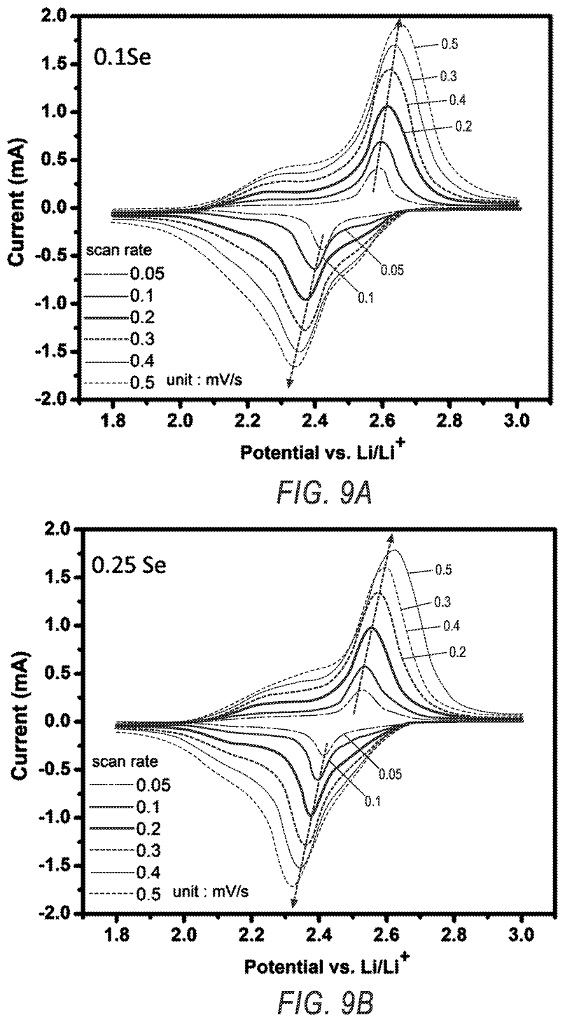

Further, the cyclic voltammetry curves of 0.1 and 0.25 Se substituted compositions at different scan rates are shown in FIGS. 9A-9B. According to Randles-servick equation, the relation between peak current and scan rate was validated by plotting peak current vs square root of the scan rate. The slope of the linear fit is related to the diffusion properties of the Li-ions in the electrode, resulting in that the higher the slope value means the faster the Li-ion diffusion rate. Interestingly, based on the slope values, during charging reaction, the 0.1 Se composition expected to have high diffusion rate and 0.25 Se has high diffusion rate during discharge. This clearly conveys that the Se content in the electrode composition improves the lithiation or discharge reactions compared to less Se content compositions. Further, the excellent cycling stability test could be attributed to the Se redox involvement that can have possibilities to reduce electrochemical stress on sulfide anion redox during extended electrochemical reactions. Conventionally, anion redox is highly argued in oxide cathodes where the anion redox stability is highly questionable, and fundamental issues such as voltage fade, voltage hysteresis, and irreversible oxygen release are prevalent during continuous charge discharge cycling. Conversely, chalcogen anion redox demonstrates superior properties in terms of voltage fade and voltage hysteresis in one of the seminal compositions. On the other hand, all other chalcogen compositions even in sulfide frameworks exhibit moderate cycle life even after nanosizing or surface modification procedures. While previous studies demonstrated Se addition in Li₂FeS₂ frameworks, the electrochemical performance and reversibility were subjected to drastic capacity degradation after adding Se substitution.

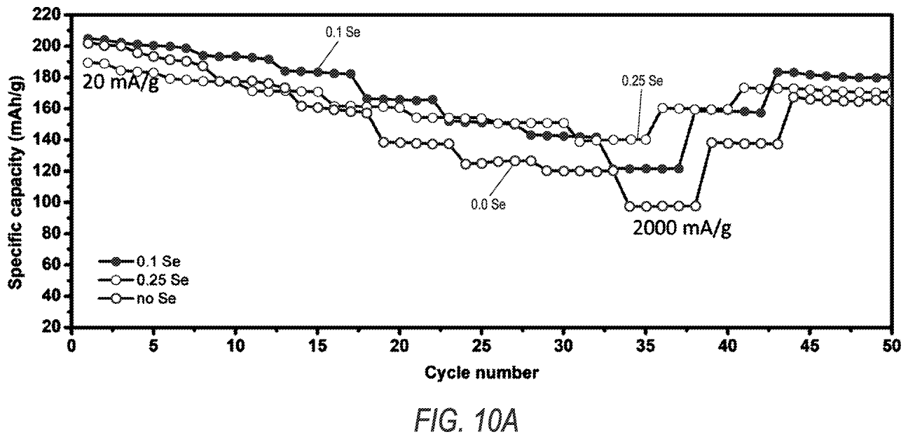

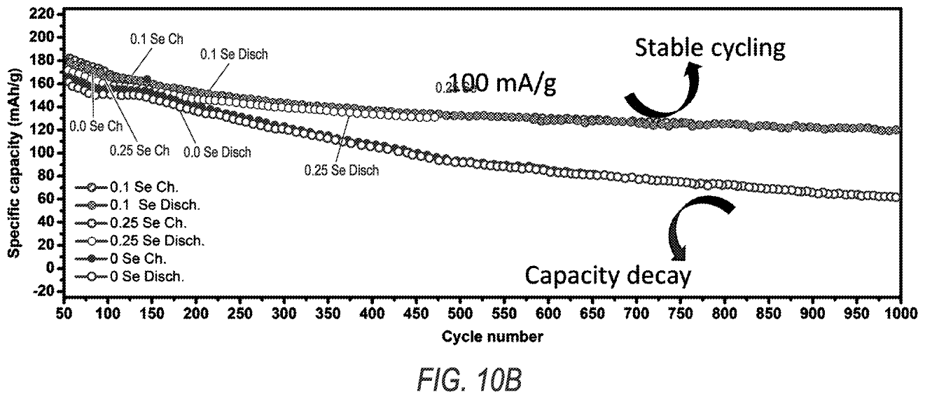

Considering the existing chalcogen anion redox works, the cathode composition attempted with Se substitution according to the present disclosure exhibited excellent cycle stability and rate performance, suggesting that an appropriate amount of Se incorporation in chalcogen frameworks may be utilized for achieving highly stable cathode materials. Interestingly, kinetic polarization of the observed voltage profiles at different current densities seems to be minimal, indicating that the rate performance is an intrinsic behavior of the material rather than the sole correlation of electronic conductivity (ohmic polarization) of the materials. Even after high-rate testing (inset: first 40 cycles), the 0.25 Se-substituted composition exhibits excellent reversibility for up to 1000 continuous charge-discharge cycles with gradual capacity decay (FIG. 5C). As a comparison, electrochemically important compositions (y=0.1 and 0.25) are evaluated for rate dependency (up to 10 C) with zero Se composition followed by cycling stability at 100 mAh/g (approximately C/2) (FIG. 10A-10B). Compared to zero Se composition, 0.1 and 0.25 Se exhibit excellent stability even after handling an extremely high rate for about more than 10 C charge-discharge rate, confirming that the Se addition can modify the electronic structure of the sulfide framework for achieving a better rate capability and cycling stability. Also, the observed understanding could be extended to couple with chalcogen solid state electrolyte for interfacially stable solid-state batteries. Also, the Se adding strategy can be explored for developing high-rate capable cathodes and oxide analogs for better anion redox oxide cathode materials.

### Understanding Anionic and Cation Redox Activity: Ti and S K-Edge

To further understand the redox participation of the elements, synchrotron XAS spectroscopy measurements of the S, Se, Ti and Fe K edges were carried out in cathode materials at different states of charge. In this cathode, it is expected that Li extraction is compensated by metal ion redox and anion redox reaction in the potential window. Therefore, the anion redox participation will be initially evidenced by surface-sensitive Near Edge X-ray Absorption Fine Structure (NEXAFS) measurements.

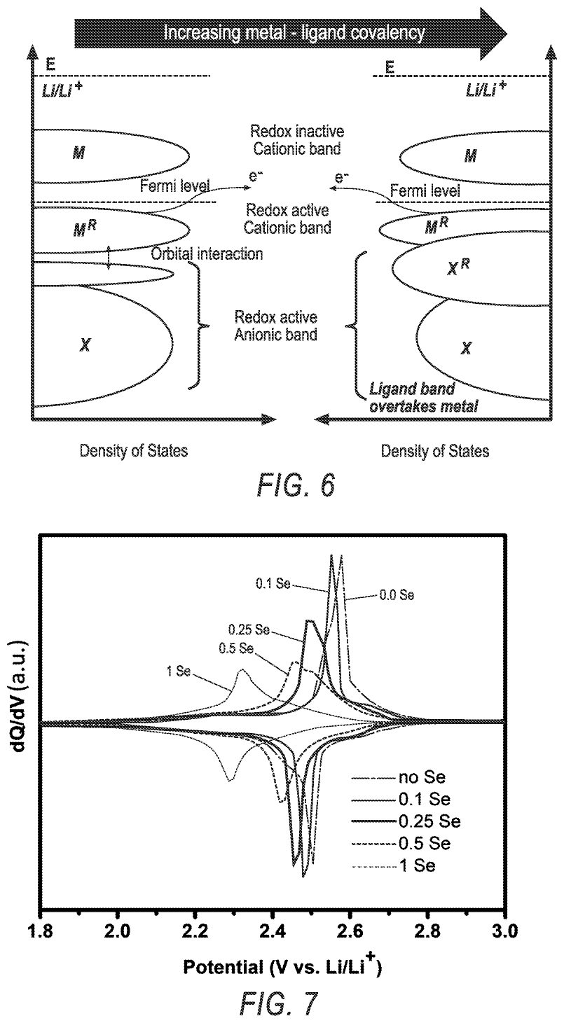

First, the NEXAFS measurement was carried out to analyze Ti redox activity in the potential region. Here we will focus on two portions of the absorption spectra: 1. Pre-edge feature, 2. Main absorption edge peak. The pre-edge feature is sensitive toward the oxidation state and coordination environment of the absorbing atom being probed. In this chalcogen composition, the Ti cation is in a tetravalent state with an octahedral coordination environment. When the Ti is present in a tetravalent state, the Ti 3d orbital is empty with 3d⁰ (t₂_{_{g}}⁰ e_{g}⁰) orbital configuration. Therefore, Ti oxidation beyond Ti⁴⁺ will not be possible during Li extraction reaction since the d orbital has no electrons to compensate for Li extraction. Based on the main peak, the main absorption edge peak is ascribed to a transition of is electron to unoccupied 4p orbital. In order to prove inactivity, the Ti K edge NEXAFS measurements were evaluated. Initially, the in-depth X-ray spectroscopy analysis was conducted for y=0.5 and extreme y=1 Se cases to understand possible charge compensation mechanisms during different charge conditions. In both cathode compositions, when charging to 3 V, the Ti K edge spectra exhibit some changes in the line shape of the edge which is possibly due to the changes in the local environment of Ti during electrochemical reactions. However, the Ti K edge spectra exhibits no rigid shifts at charged states, indicating that the Ti⁴⁺ cation is not taking part in the electrochemical reaction in the potential window of 1.8 V to 3 V vs. Li. However, there are significant changes in the pre-edge regions. A slight hump-like feature around 4968 eV corresponds to the dipole-forbidden transition of 1s-to-3d states with t₂_{_{g}} symmetry coordinated in the octahedral environment of Ti cations. Next, the P2 peak is dipole-allowed states of is to hybridized 3d/4p orbital states. Generally, the electric dipole transition is forbidden for is to 3d transition but allowed due to hybridized 3d/4p orbital states (p component rather than d component). Interestingly, the P2 intensity is sensitive to orbital symmetry environments, the intensity variation can be correlated to displacement of Ti⁴⁺ cation in the Ti—Ch(S/Se)₆ environment. There is a progressive decrement in the pre-edge intensity at different states of charge for the y=0.5 and 1 Se compositions. Also, the P2 pre-edge intensity decreased to the maximum at a fully charged state for the high Se composition, suggesting that anion oxidation during charge (S/Se) improves covalency between metal and chalcogen ligands that resulted in the shortening of Ti—Ch(S/Se) bond length (improved tightness). This phenomenon can be further strengthened with the amount of Se content, confirming that high Se content in the Ti metal octahedron affects the metal-ligand bonding compared to low Se environment during redox reactions. The interaction between metal and ligand can lead to distortion in a high Se content MS₃Se₃ (MCh₆) octahedral environment confirming that the pre-edge intensity is decreased due to changes in the local octahedral symmetry. In addition, the other P3 and P4 peaks also substantiate this behavior when high Se content composition has significant line shape variations compared to y=0.5 compositions at a fully charged state. Interestingly, the observed behavior is completely reversible that clearly confirms that the Se-substituted chalcogen anion redox reaction is not leading to any irreversible changes such as metal migration or redox couple evolutions that are well evidenced with even surface sensitive techniques. Fundamentally, Se has less electroactivity than S, implying that Se 4p band lie above the S 3p band in the designed composition. Therefore, a hypothetical band diagram is shown in FIG. 6, where the Fe 3d states are occupied near the Fermi level followed by Se 4p and S 3p states. With these band positions, electrochemical charge compensation for Li transfer will be utilized by the Fe 3d electrons. Once the appropriate 3d electrons are removed within the potential limitation, highly covalent Fe—(Se/S) interaction leads to triggering chalcogen anion redox reactions.

Further, the reversible anionic redox participation was evaluated using S K-edge spectra at different states of charge conditions including different Se-substituted compositions. The involvement of anions (S²⁻/Se²⁻) in the redox participation was identified by observing significant changes in the spectral features of S/Se K edge spectra. The pristine composition exhibited a strong white line signal around 2470 eV which is comparable to previous S K-edge measurements of various alkali metal and transition metal sulfides. Further, when half of Li is extracted, no new or additional spectral features are observed, but the white line intensity is increased while the intensity of the high energy features is decreased. The reason for the intensity increase is due to the improved covalency between transition metals and sulfur ligand during charging. Since initial Li extraction is expected to be compensated by transition metal redox, the oxidation of transition metal along with sulfur redox participation will improve the tightness between TM 3d and S 3p orbitals. However, for fully charged state, a distinct shoulder peak emerged at low edge energy and the shoulder was suppressed during the discharge state, implying that the S redox participation is reversible during electrochemical reactions. Fundamentally, when anions have participated in redox reactions, anion oxidation reactions increase electron holes on the anions and this increase in electron holes could be reflected as a hump/shoulder in the S K edge spectra at different states of charge conditions. Per S K edge spectra, the S² anion is oxidized and the electron holes are created on top of S 3p band, and the electron holes are increased when the sulfur attained a high oxidation state compared to pristine. With this understanding, we qualitatively confirm that the shoulder peak was observed reversibly during the electrochemical reaction of the cathode, and this behavior is attributed to the reversible sulfide anion redox nature in this cathode composition even after Se introduction.

HAXPES investigation: S 1s and Se 2p: To further understand the anion redox participation, HAXPES was introduced to analyze the cathode material at different cycling conditions. Conventionally, the anion redox reaction in oxide cathodes led to various surface reconstructions and interfacial reactions between reactive anion redox species and electrolytes, the anion redox-induced depth-dependent surface species have been understood using HAXPES technique previously for oxide cathodes. This technique can be used to elucidate the chalcogen anion redox interaction with electrolyte species, if any, at different states of charge, and their depth-dependent evolution of surface species along with anion redox features can be probed. Additionally, in conventional XPS, the common S 2p and Se 3d core lines overlap in the binding energy region of 160 eV to 170 eV, leading to difficulties in understanding the individual anion redox contribution in the cathodes. To avoid this confusion, an advantage of the HAXPES technique was used where a tunable photon energy can access S is (2472 eV) and other Se core lines such as Se 2p (Se 2p_{3/2} at 1435 eV) without any overlapping regions. The measurements were performed using the photon energies of 3100 eV in which the photon energy will give access to S 1s and Se 2p measurements; additionally the high photon energy will probe much depth due to its increase in kinetic energy compared to conventional XPS. HAXPES measurements of S 1s and Se 2p spectra measured at the photon energy of 3100 eV were taken The S 1s spectra showed three significant peaks observed around 2470 eV, 2472 eV, and 2480 eV. The peak at 2470 eV is attributed to the metal-ligand feature (M-S) which is consistent with reported references. Further, a contribution at the peak around 2472 eV is due to the intermediate contribution such as Sⁿ⁻ (n<2) signal. Finally, the peak at higher binding energy around 2480 eV is due to the oxygenated species from the electrolyte interaction. Unfortunately, there is a limited literature database for alkali-metal sulfide or transition-metal sulfide S is spectra; we thus correlate these peak assignments with our best possible understanding of the available literature references. After the cathode is charged to 3V, the peak intensity at 2470 eV was increased and this behavior was reversed during the discharged state. Fundamentally, peak intensity increase is due to the number of electron holes increased around the S atom, indicating that the oxidation of S anionic species increased the electron holes and reversed similar to pristine state due to reversible redox contribution of S anionic species.

Further, the same photon energy of 3100 eV was used to measure the Se 2p core line that cannot be accessed through conventional photoelectron spectroscopy. The Se 2p spectra of different charge states was measured. Due to limited existing literature evidence for Se 2p peak assignments, the peak assignments were identified with the available references in the best possible way. Accordingly, in Se:S based polymeric component, the Se 2p photoemission peak collected at 3100 eV revealed three different species: Se−Se at 1435 eV, Se—S/C at 1435.6 eV and Se—O at 1438.6 eV. According to the present disclosure, the Se 2p exhibits a doublet-like feature with two distinct peaks for all the sample conditions starting from pristine to cycled state. Interestingly, at fully discharged state, the doublet feature is clearly visible, but the distinct peak-like feature vanishes at fully charged state. Based on the peak positions, we assign Se—S/Se—Se to a region in the range of 1436 eV to 1434 eV. A peak at lower energy may be attributed to the M-Se bond similar to M-S species was observed. The feature around 1435 eV evolved when fully charged the cathode to 3V, indicating that the feature could be attributed to the Se anionic redox contribution or Se anion valence state evolution. However, the doublet feature is recovered in all the discharged states, confirming that the Se redox contribution is highly reversible during electrochemical reactions. In the cycled state, a shoulder feature is visible, but the relative intensity of the peaks is high compared to other fully discharged states. In addition, the pristine composition is also similar to the cycled state, suggesting that the initial Se species may have mixed valence states and the feature at cycled state may be attributed to the mixed valence state that resulted from the extended cycling conditions. We correlated Se 2p spectra mainly with the shape changes and relative intensity variations at different states of charge conditions. To further support this Se redox contribution, we extended the analysis to bulk sensitive hard X-ray absorption spectroscopy to elucidate bulk Se local redox participation and local environment at different states of charge and different Se substituted compositions.

### Hard X-Ray Absorption Spectroscopy Investigation: Se and Fe K-Edges

After understanding the redox species using NEXAFS and HAXPES investigations, the redox contribution of Se species was investigated using hard X-ray Absorption spectroscopy investigation to identify redox state variation and changes in the local coordination environment due to covalent interaction between metal-ligand bonding during Se anion redox reactions. The XAS spectrum consists of mainly Xray absorption near edge structure (XANES portion) and extended absorption features named EXAFS. The measurements showed Se K edge spectra of different Se-substituted compositions at various states of charge conditions. Specifically, the extreme and moderate Se-substituted compositions were used and mainly the moderate Se compositions are electrochemically more important than other Se compositions. The Se K edge spectra for the Li_{1.13}Ti_{0.57}Fe_{0.3}SiSe₁ exhibited a few important spectral features, mainly the white line intensity, arising from 1s to 4p unoccupied energy transition, varied with both the Se valence state variation and bonding environment changes. As observed, there are two spectral features observed (i) white line intensity variation at 12657 eV; and (ii) near-edge peak intensity variations. The intensity variation associated with the white line is mainly attributed to the Se valence state during the Se redox contribution. This white line intensity was previously correlated to identify Se valence states in various Se-based compositions such as Se (VI), Se (II), and Se(0). Fundamentally, the white line gains intensity as valency increases, which is directly attributable to a decrease in the population of the 4p valence levels. Similarly, a feature observed at 12665.5 eV has a strong correlation to its local environment, and Se anion oxidation significantly reduced the intensity and shifted to a high-energy region. With these spectral features, the Se redox contribution was clearly identified in Se substituted compositions. First, the high Se content composition (y=1) was evaluated where the pristine compositions exhibited an increased white line intensity and a scattering feature was observed in between the fully charged and fully discharged conditions. This behavior may be due to the mixed valence states of Se species either from the solid state synthesis or the presence of Se species from the pristine composition. In addition, in the fully charged state, the white line intensity was increased and a scattering feature at 12665 eV was shifted to high energy that clearly indicates the oxidation of Se species. However, after the 1^{st} cycle discharged state, the white line intensity was reduced and the scattering feature was shifted to low energy, indicating that the oxidized Se anion is reversed to lower valence state, especially Seⁿ⁻ (n<2) to Se²⁻. A similar feature was replicated in the 2^{nd} discharged state of Li_{1.13}Ti_{0.57}Fe_{0.3}SiSe₁, indicating the complete reversibility of Se electronic structure and local environment during Se anion redox contribution. Further, the XAS spectroscopy investigations were extended to analyze lower Se content compositions that are electrochemically superior to other Se substituted compositions. Similar to Li_{1.13}Ti_{0.57}Fe_{0.3}SiSe₁, the Se K edge spectra of y=0.25 and y=0.1 Se substituted compositions look similar and no additional spectral features were observed compared to high Se content composition. This observation once again confirms that the Se substitution has not significantly modified the local environment significantly. Two different Se compositions were investigated for different state of charge conditions: Pristine, charged to 3V, and discharged to 1.8V and 1.7 V vs Li. After understanding the electrochemical importance of lower Se compositions, the discharge voltage of the Se composition was slightly lowered from 1.8 V to 1.7 V, because the slight extension in discharge voltage may lead to a significant change in local environment as it was proven previously in Li₂TiS_{1.5}Se_{1.5} composition. The Se K edge spectrum of pristine composition exhibited similar features except slight intensity variation between the two compositions. At the fully discharged state, the two compositions exhibited main absorption peak responsible for 1s-to-4p transition and a scattering feature located around 12665 eV. Compared to y=0.25 Se, the y=0.1 Se composition main peak intensity has reached slightly high and a scattering feature around 12665 eV was also shifted to high energy. The observed behavior may be attributed to the significant contribution of Se species because less Se content in the composition may have the possibility to contribute more Se redox to achieve targeted approximately one Li transfer electrochemical reactions. Conversely, more Se content in the composition technically reduces the gravimetric capacity of the composition due to heavier mass of Se compared to the S ligand, and the available Se contribution towards achieving one Li transfer may not need whole Se content compared to S and Fe redox contribution in the overall composition. Even though the changes in terms of energy shifts are minimal, the fundamental reason is that when the structure has more Se content, the demand for reaching 1 Li transfer through Se redox is less because the redox reaction will be compensated mainly through Fe^{2+/3+} and S redox reactions. Despite similar features, the relative intensity between the main absorption peak and high energy scattering feature is not of the same magnitude. This observation can be correlated with the previous explanation focusing on the relation between Se content and demand for Se redox contribution for high Se content compositions. At fully discharged state, lower Se content compositions exhibited high intensity scattering features compared to high Se content compositions. Fundamentally, it is believed that the involvement of Se contribution to the 1 Li transfer reaction is relatively high in lower Se composition. Considering high reversibility with high capacity in Se compositions, the fundamental reason could be attributed to the Se electrochemical contribution and changes in the covalent interaction between the Fe—S/Se octahedral frameworks. In this family of chalcogen anion redox compositions, the Li insertion/extraction reaction is mainly compensated by cationic Fe redox and anionic S redox reaction; the Se substitution in the model composition is to evaluate the electronic structure dependent electrochemical advantage in terms of rate and electrochemical reversibility. Selenium is partially occupied sulfur site in the chalcogen structural framework. Considering redox active Fe—(S/Se) octahedral regions, the S redox and Fe cation redox will have a huge possibility to change Se bonding environment as Se also will preferentially contribute towards electrochemical reaction. The interaction between metal and ligand during combined cationic and anionic redox will certainly influence the spectral features of individual species in terms of metal-ligand covalency perspective.

### Fe K-Edge Investigation:

With this anion redox understanding, the electrochemically important compositions were analyzed for cation redox contribution using Fe K edge spectroscopy investigations. Observations of the Fe K edge spectra of the lower Se substituted compositions at different states of charge conditions were made. The general features of the Fe K edge consist of low energy pre-edge, rising edge, K edge main peak, and high energy photoemission scattering peaks. The observed Fe K edge spectra of the Se substituted cathode materials look like iron chalcogenides (Li₂FeS₂, FeS₂, FeSe, FeSe₂) previously reported for both octahedral and tetrahedral coordination. Similarly, the Fe K edge spectrum was marked with the identified features: Pre edge A, rising edge B, K edge C, and high energy scattering feature D. First, the pre-edge peak at 7112 is due to the 1s-to-3d transition through a weak quadrupole transition. In octahedral symmetry, the 1s-to-3d electric dipole transition is forbidden but partly allowed through electronic quadrupole transitions due to the admixed p-orbital states. The strength, as well as the intensity of the pre-edge peak, is strongly influenced by the coordination environment, local geometry or distortion associated with the absorbing atomic environment. The rising edge is due to the absorption edge jump that is mainly ascribed to the 1s-to-4p transition. Further, the main absorption edge is due to the transition from the 1s-to-4p state admixed with the d states from the chalcogen (S/Se) atoms. Finally, the high energy peak features are due to the photoemission scattering process with the near neighbors. The pre-edge intensity is not strong or intense for all the state of charge conditions compared to other tetrahedral Fe—Ch(S/Se) environments in the existing literature. Fundamentally, electric dipole transitions are allowed through p-d hybridization in tetrahedral geometry, but the octahedral geometry can proceed through electric quadrupole transitions that are much less intense than the dipole transitions. In the chalcogen framework, the Fe atom is coordinated with six ligands in octahedral coordination. In addition, the Fe—Ch(S/Se) environment is more covalent than metal-oxygen environment that covalent interaction will also support the less pre-edge intensity. By carefully looking at the pre-edge features, the pristine and discharged state conditions exhibited only minimal changes in the spectral features, but the charged states exhibited slightly higher intensity than the other conditions. At fully charged state, the observed behavior is due to higher degree of covalency that is resulted from the mixed cation/anion redox reactions. In this Fe—Ch(S/Se)₆ octahedral geometry, when fully charged, the Fe and chalcogen (S/Se) are involved in redox reactions that could increase the tightness between the metal and ligand, leading to distortion in the original octahedral geometry as shown in scattering features of Fe K-edge features. Therefore, the pre-edge features clearly indicate that the reversible Fe^{2+/3+} redox and covalent interactions between metal and chalcogen ligands during electrochemical redox reactions. Next, the rising edge energy is attributed to the oxidation state of the absorbing atom. The edge energy shift is well visualized in the first derivative of Fe K-edge spectra. In general, the absorption edge is determined by the first inflection point in the derivative spectrum or half maximum of the K edge spectrum. During fully charged state, the first derivative of the y=(0, 0.25, and 0.1) compositions shifted from 7117 eV to 7118.5 eV as a result of Fe cation oxidation changes to a higher oxidation state from pristine Fe²⁺. One more thing to note here is that the pristine state of y=0.25 has slightly shifted beyond the edge energy (E₀) discharged state and y=0.1 Se pristine state, indicating that may be due to the partially oxidized species beyond 2+ in the pristine material from the synthesis. Based on the original composition, the structural framework is highly ordered with transition metal/Li mixed layer, and the lithium layer is sandwiched between chalcogen stacking (O3-type stacking). The shifted rising edge and the first derivative peak around 7117 eV reversed back to the lower E₀ edge energy upon the discharged state, indicating that the Fe cationic redox reaction is reversibly occurring during electrochemical charge discharge reactions. Further, white line main peak intensity slightly decreased in intensity, and also the peak shape changed to intense upon charging which is clearly observed in Fe K-edge NEXAFS spectra and first derivative spectra of the Fe K-edge spectra. This phenomenon is mainly due to the large mixing of Fe d−Ch(S/Se) p states, resulting in high S/Se degree of covalency when utilizing cationic and anionic redox at high state of charge. There is no significant deviation in y=0.25 and y=0.1 Se-substituted composition, but the magnitude of energy shifts is almost similar during charging and also observed during discharge. In addition, the y=0.25 and y=0.1 compositions cut off voltage of 1.7 V has no effect on the spectral features of y=0.25 and y=0.1 Se substituted compositions, indicating that the Fe valence state variation in the 100 mV difference is negligible. Finally, the high energy features exhibited minor changes at fully charged and discharged states, leading to a highly reversible Fe redox reaction spectroscopically, and electrochemical studies exhibited highly reversible electrochemical lithiation and delithiation reactions. This behavior is contrary to the existing Se substituted composition in lithium iron sulfide cathodes. Se substitution in Li₂FeS₂ yielded a huge capacity fade and lost over 80% of initial capacity within 100 charge discharge cycles at C/10 current rate. Also, sulfide compositions in other structural motifs such as anti-perovskite and layered sodium cathodes exhibited relatively less cycling stability, and all are majorly limited to only 100 cycles with greater capacity decay. However, according to the present disclosure, the Se substitution yields additional stability and rate capability in the sulfide framework and compensates partial charge contribution for achieving highly reversible Se substituted chalcogen cathode materials free from Ni and Co metals.

According to the disclosure, reversible multi anion chalcogen redox was investigated in the Li_{1.13}Ti_{0.57}Fe_{0.3}S_{2-y}Se_{y} (y=0, 0.1, 0.25, 0.5, and 1) structural framework with varied Se compositions. Different Se compositions were confirmed with X-ray powder diffraction measurements where a systematic shift in Bragg peaks confirmed the Se mixing in the lattice and further lattice expansion. The effect of Se on the electrochemical reversibility involving multi component redox [Fe^{2+/3+}/(S²⁻/Sⁿ⁻)/(Se²⁻/Seⁿ⁻), wherein n<2] in Li-rich chalcogen environment was investigated. The Se addition significantly affected the electronic structure of the chalcogen composition and electrochemical properties such as average redox voltage, cyclability, and rate capability. From the electrochemical investigation, the Se added compositions exhibited excellent reversibility for up to 1000 cycles at C/2 rate even after initial high-rate (1 C) charge-discharge reactions. Interestingly, after Se addition, the chalcogen framework exhibited high-rate capability for more than 10 C with more than 50% of capacity obtained at C/20 rate. In addition, the systematic shift in voltage profiles was observed when Se content increases, indicating that Se is the key contributor to control oxidation and reduction potential in the chalcogen anion redox composition. Further, in-depth X-ray absorption investigation revealed that the spectral features of Fe, S, and Se K edge are highly reversible, and all contributed to electron transfer reactions in the potential region of the study. In contrast to other works, the Se addition in the chalcogen framework improved electrochemical reversibility, and also the Ti⁴⁺ environment was not distorted to activate Ti redox in the compositions. The Ti inactivity was proved using Ti K edge NEXAFS measurements.

### Experimental and Materials Characterization

X-ray powder Diffraction: X-ray powder diffraction (XRD) was carried out on a Bruker D8 diffractometer using Cu Kα radiation (λ=1.54 Å) in the 2θ range from 10° to 80°. To avoid air exposure to the samples, the measurement was carried out using a sealed Kapton capillary (Cole Parmer/1 mm capillary) filled with active materials.

Electrochemical characterization: The electrodes may prepared by a slurry coating method in an argon-filled glovebox. The cathode slurry was prepared by mixing active material as prepared pursuant to the method 200 (e.g., Li_{1+(1-(a+b))}TiₐFe_{b}S_{2-y}Se_{y} where a+b≤1, and y=0.1≤y≤1), conductive carbon (e.g., C-65 carbon black powder (Super P)), and binder (e.g., polyvinylidene fluoride (PVDF)) in the ratio of 80:15:05 using N-Methyl-2-pyrrolidone (NMP) as solvent. The homogeneous mixture was cast on a current collector (e.g., carbon coated aluminum current collector) using the doctor blade method. The coated electrodes (cathode) were dried at 80° C. in a vacuum oven inside glove box for at least 12 hrs. Finally, the electrodes were cut into circles and yielded a loading of 2 mg to 3 mg on each electrode. It will be appreciated that the weight ratio of the components of the cathode are not limited to the stated composition and can be varied according to the battery performance that is desired. The carbon content can be varied to adjust the electronic conductivity of the electrodes, binder content can be varied to adjust the binding between the electrode and the current collector.

All electrochemical analyses were performed in conventional coin cells, and the cells were prepared in an Ar filled glove box (O₂<1 ppm, H₂O<0.1 ppm). Li foil (75 um) was used as anode and its surface was cleaned using razor blades, trilayer Celgard® membrane was used as separator. A commercial 1M lithium hexafluorophosphate (LiPF₆) in ethylene carbonate (EC)/dimethyl carbonate (DMC) mixture (50/50 ratio by volume) was used as the electrolyte. It will be appreciated that other anode materials (e.g., Li₄Ti₅O₁₂ (LTO), Graphite, Alloy anodes such as Si & Sn), electrolytes (e.g., a room-temperature ionic liquid with or without electrolyte additives), and/or membranes (e.g., glass fiber) may be used without departing from the scope of the disclosure. Further, the shape and size of the components is not limiting and can be adapted to any battery form factor like pouch cells of various capacities, coin cells of different dimensions, cylindrical cells of various dimensions like 18650, 14500, 4680, etc.

All the galvanostatic tests were tested either on an Arbin battery cycler or Landt instruments at appropriate current density. The specific capacity was calculated for all electrodes based on the active material loading in the cathode. All cyclic voltametric studies were carried out using a biologic potentiostat.

Microscopy Investigation: The High-Resolution Transmission Electron Microscope (HR-TEM), and High Angle Annular Dark Field-Scanning transmission Electron Microscope (HAADF-STEM) at the Center for Functional Nanomaterials, Brookhaven National Laboratory. For all the microscopy experiments, once the targeted electrodes attained desired state of charge, the electrode materials were collected from the coated slurry on the Al current collector. The collected particles were sonicated in a vial with anhydrous DMC to ensure uniform dispersion prior to drop casting on a lacey carbon coated TEM grid. Extreme care was taken to avoid air exposure of the samples, and the sample preparation was carried out in an Ar filled glove box. The bright field HR-TEM was obtained with a JEOL2100F TEM instrument at an accelerating voltage of 200 kV.

Ex-situ XAS: Ex-situ X-ray Absorption Spectroscopy measurements were performed at the Advanced Photon Source beamline 20-BM-B at Argonne National Laboratory. The incident beam energy was monochromatized by Si (111) crystal monochromator. The energy calibration was performed by simultaneously measuring Se and Fe metal foils. The spectra were acquired in transmission mode using gas ionization chamber as detectors. Once the coin cells attained their desired state of charge, the samples were collected from the coin cells and washed with DMC three times inside a glovebox. After complete drying, the collected electrodes were sandwiched between Kapton films and pasted on an appropriate beamline sample plate. The sealed samples were sent to the beamline end station while completely avoiding air exposure. The Se and Fe K edge data were processed (normalization, calibration, and energy alignment) with ATHENA software package. All Fe K edge spectra were energy aligned with respect to the first derivative peak of the Fe reference foil at 7110.75 eV as described in Kraft et al.

HAXPES & NEXAFS: Investigation: The HAXPES measurements were performed at the National Institute of Standard and Technology beamline 7-ID-2 (SST-2) of National Synchrotron Light source II of Brookhaven National Laboratory, using a 400 mm diameter concentric hemispherical analyzer oriented parallel to the photon polarization axis and perpendicular to the photon propagation axis. The HAXPES experiments were carried out using 3100 eV photon energy. The 3100 eV photon energy selection was achieved using a double Si (111) crystal monochromator, and the measurement was carried out with a pass energy of 100 eV. Samples were mounted at a 10° incident angle for an 80° takeoff angle.

S and Ti K-edge measurements were collected in the same endstation using the sample drain current normalized to the beam intensity collected from a 1 μm-thick Al foil just upstream of the endstation. For both HAXPES and NEXAFS measurements, an unfocused x-ray beam was used and slit down to a size of approximately 0.5 mm by 0.5 mm. For NEXAFS, samples were mounted for normal incidence.

When introducing elements of various embodiments of the disclosed materials, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While the preceding discussion is generally provided in the context of a cooling device to be used on hands or feet of a chemotherapy patient, it should be appreciated that the present techniques are not limited to such limited contexts. The provision of examples and explanations in such a context is to facilitate explanation by providing instances of implementations and applications. The disclosed approaches may also be utilized in other contexts or configurations such as cold therapy helmets. The device may also be reconfigured to a different temperature range, providing heating or cooling for treatments such as for physical therapy, postoperative cooling, or treatment from sports injuries.

While the disclosed materials have been described in detail in connection with only a limited number of examples, it should be readily understood that the embodiments are not limited to such disclosed embodiments. Rather, that disclosed can be modified to incorporate any number of variations, alterations, substitutions or equivalent arrangements not heretofore described, but which are commensurate with the spirit and scope of the disclosed materials. Additionally, while various embodiments have been described, it is to be understood that disclosed aspects may include only some of the described embodiments. Accordingly, that disclosed is not to be seen as limited by the foregoing description, but is only limited by the scope of the appended claims.

When introducing elements of various embodiments of the disclosed materials, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While the preceding discussion is generally provided in the context of Lithium ion batteries, it should be appreciated that the present techniques are not limited to such limited contexts. The provision of examples and explanations in such a context is to facilitate explanation by providing instances of implementations and applications. The disclosed approaches may also be utilized in other contexts or configurations.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary. Further, the use of “at least one of” is intended to be inclusive, analogous to the term and/or. As an example, the phrase “at least one of A, B and C” includes A only, B only, C only, or any combination thereof (e.g. AB, AC, BC or ABC). Additionally, use of adjectives such as first, second, etc. should be read to be interchangeable unless a claim recites an explicit limitation to the contrary.

What is claimed is:

1. A fast charge capable cathode material for an insertion ion battery comprising:
a composition having the formula: AₓMCh_{y}, wherein x is 1 to 5; y is 2 to 5; A is selected from the group consisting of: Li, Na, K, Mg, and Ca; M is selected from the group consisting of Ni-free and Co-free d-block transition metals or p-block metals or combination of two or more thereof; Ch is selected from the group consisting of S and/or Se alone or combined with O and/or Te.

2. The cathode material of claim 1, wherein the d-block transmission metals are selected from the group consisting of: Ti, V, Cr, Mn, Fe, Cu, Zr, Nb, and Mo.

3. The cathode material of claim 1, wherein the p-block metals are selected from the group consisting of: Al, Sn, Sb, Si, and In.

4. The cathode material of claim 1, wherein the composition has the formula:
$${Li}_{1 + ( 1 - ( a + b ) )} {M}_{a} {M}_{b}^{R} {X}_{2 - y} {X}_{y}^{R} ,$$
wherein a+b≤1; y=0.01≤y≤1; M and M^{R} are selected from the group consisting of the Ni-free and Co-free d-block transition metals or P-block metals or combination of two or more thereof; X and X^{R} are selected from the group consisting of S and/or Se alone or combined with O and/or Te.

5. The cathode material of claim 4, wherein the composition has the formula:
$${Li}_{1 + ( 1 - ( a + b ) )} {Ti}_{a} {Fe}_{b} {S}_{2 - y} {Se}_{y} ,$$
wherein a+b≤1, and y=0.1≤y≤1.

6. The cathode material of claim 5, wherein the composition has the formula:
Li_{1.13}Ti_{0.57}Fe_{0.3}S_{2-y}Se_{y}, wherein y=0.1, 0.25, 0.5, or 1.

7. A lithium-ion battery, comprising:
an anode;
a cathode;
a separator disposed between the cathode and the anode; and
an electrolyte in contact with the anode and the cathode;
wherein the cathode has a composition with the formula: AₓMCh_{y}, wherein x is 1 to 5; y is 2 to 5; A is selected from the group consisting of: Li, Na, K, Mg, and Ca; M is selected from the group consisting of Ni-free and Co-free d-block transition metals or p-block metals or combination of two or more thereof; Ch is selected from the group consisting of S and/or Se alone or combined with O and/or Te.

8. The lithium-ion battery of claim 7, wherein the separator comprises a microporous polymer membrane.

9. The lithium-ion battery of claim 7, wherein the cathode is coated onto a carbon current conductor.

10. The lithium-ion battery of claim 7, wherein the anode comprises an Li foil or Li₄Ti₅O₁₂ (LTO) or Graphite or an Si alloy or an Sn alloy.

11. The lithium-ion battery of claim 7, wherein the electrolyte comprises 1M lithium hexafluorophosphate (LiPF₆) in ethylene carbonate (EC) and dimethyl carbonate (DMC).

12. The lithium-ion battery of claim 7, wherein:
the d-block transmission metals are selected from the group consisting of: Ti, V, Cr, Mn, Fe, Cu, Zr, Nb, and Mo; and
the p-block metals are selected from the group consisting of: Al, Sn, Sb, Si, and In.

13. The lithium-ion battery of claim 7, wherein the composition has the formula:
$${Li}_{1 + ( 1 - ( a + b ) )} {M}_{a} {M}_{b}^{R} {X}_{2 - y} {X}_{y}^{R} ,$$
wherein a+b≤1; y=0.01≤y≤1; M and M^{R} are selected from the group consisting of the Ni-free and Co-free d-block transition metals or P-block metals or combination of two or more thereof; X and X^{R} are selected from the group consisting of S and/or Se alone or combined with O and/or Te.

14. The lithium-ion battery of claim 13, wherein the composition has the formula:
$${Li}_{1 + ( 1 - ( a + b ) )} {Ti}_{a} {Fe}_{b} {S}_{2 - y} {Se}_{y} ,$$
wherein a+b≤1, and y=0.1≤y≤1.

15. The lithium-ion battery of claim 13, wherein the composition has the formula:
Li_{1.13}Ti_{0.57}Fe_{0.3}S_{2-y}Se_{y}, wherein y=0.1, 0.25, 0.5, or 1.

16. A method of forming a cathode active material for an insertion ion battery comprising the steps of:
a) providing precursors of Li₂S, Ti, Se, and FeS;
b) mixing the precursors in a stochiometric amount to obtain a desired composition;
c) heating the mixed composition in a predetermined process to form the desired composition with the formula Li_{1+(1-(a+b))}TiₐFe_{b}S_{2-y}Se_{y}, wherein a+b≤1 and y=0.01≤y≤1; and
wherein Se²⁻ ions are doped into S²⁻ ion sites.

17. The method of claim 16, wherein mixing the precursors includes grinding with a mortar and pestle for a predetermined duration in an inert environment.

18. The method of claim 16, wherein heating the mixed composition in the predetermined process includes sealing the mixed composition under vacuum and heating to a predetermined temperature at a predetermined heating rate.

19. The method of claim 18, wherein the predetermined temperature is about 750° C. and the predetermined heating rate is about 30° C./hour.

20. The method of claim 18, wherein the predetermined process further includes cooling the mixed composition from the predetermined temperature to room temperature at a cooling rate of 30° C./hour or 60° C./hour.
